(19) United States
(12) Patent Application Publication
(10) Pub. No.: US 2020/0151788 A1
(43) Pub. Date: May 14, 2020

(54) SECURE ORDERING METHODS

(71) Applicants: Richard P. FOX, JR., North Huntingdon, PA (US); Patricia A. Remo, Tarentum, PA (US)

(72) Inventors: Richard P. FOX, JR., North Huntingdon, PA (US); Patricia A. Remo, Tarentum, PA (US)

(73) Assignee: Fox IV Technologies, Inc., Export, PA (US)

(21) Appl. No.: 16/678,327

(22) Filed: Nov. 8, 2019

Related U.S. Application Data
(60) Provisional application No. 62/757,946, filed on Nov. 9, 2018.

(51) Int. Cl. G06Q 30/06; G06Q 20/40; G06Q 20/32; G06Q 20/38

(52) U.S. Cl. CPC G06Q 30/0609; G06Q 20/382; G06Q 20/3226; G06Q 20/401

(57) ABSTRACT

A secure method for submitting purchase orders wherein a QR scanner and email platform such as in an iPhone™ (14) prepares an email message for the purchase of goods or services from the scan of a two-dimensional bar code (10). The email is transmitted to computer (22) of a provider for the goods or services through servers (24 and 26) that cooperate through Internet cloud (28). Computer (22) compares source data in the email message against pre-determined source data stored in computer (22) and an acknowledgement email is returned to iPhone (14) if there is a positive comparison. In some cases, the provider is not authorized to complete the order until the source receives the acknowledgement at iPhone (14) and returns a confirmation to computer (22).

### RELATED APPLICATIONS

The present application claims priority to U.S. Provisional Patent Application No. 62/757,946 filed Nov. 9, 2018, the entirety of which is incorporated herewith.

### BACKGROUND OF THE INVENTION

### Field of the Invention

The presently disclosed invention concerns methods for ordering goods and services and, more specifically, methods for quickly and reliably ordering goods and services that are secured against fraudulent acts and data entry errors.

### Discussion of the Prior Art

Many methods for ordering goods and services from suppliers are known in the prior art. However, a persistent problem has been to avoid mistakes that are caused by data entry errors. For example, data entry errors frequently result in the shipment of goods of the wrong type or in the wrong quantities. Similarly, entry errors sometimes result in the presentation of unwanted or ill-suited services. Such mistakes result in substantial delay and expense for both buyers and sellers. Accordingly, an order delivery system that could substantially reduce the risk of such mistakes would have advantages for all parties.

In addition to order errors, fraudulent interventions in the order chain also can lead to substantial financial losses and unnecessary strains in relationships between buyers and sellers. Ordering systems are becoming progressively further automated by electronically-driven platforms. While such systems offer significant advantages in speed, efficiency and convenience, they also can be subject to fraudulent schemes and corrupt practices that can quickly override the potential advantages that they offer.

Accordingly, there was a need in the prior art for an improved method for ordering goods and services that would tend to reduce the risk of inadvertent order entry errors and also protect against fraudulent attempts of third parties to create errors that would result in the mis-delivery of goods and services and/or the illicit mis-routing of payments for goods and services.

### SUMMARY OF THE INVENTION

In accordance with the presently described invention, a method for securely placing orders for goods and services includes a step of scanning a two-dimensional bar code with a suitable bar code scanner. The bar code scanner cooperates with a microprocessor or other device that is programmed to prepare an email in response to receiving data scanned from the bar code. The bar code includes data that identifies the source of the email message and also data that describes goods or services that are to be ordered from a provider so that the content of the email message that is prepared in response to the scan of the bar code is an order message that includes the identity of the source of the email and descriptive or quantity information regarding the goods or services that are being ordered.

The email message prepared from the bar code scan is transmitted to a provider who may also be identified in the email from the bar code data. When the transmitted email message is received by the provider, the provider compares the email source with a set of sources that have been pre-approved by both the source and the provider. Such comparison may be executed, for example, electronically by a data processor. If the comparison of the source corresponds positively with at least one authorized email source in the set of pre-approved email sources that the provider maintains, the provider prepares an email that acknowledges that the provider has received the email message from the source and transmits that acknowledgement email to the source. The provider may also then proceed to fill the order from the source according to the goods and services described in the source's email message.

In an alternative embodiment, completion of the order according to the source's email message may be conditioned on further steps in which the source must first receive the acknowledgement email from the provider and then prepare and transmit a confirming email that confirms that the provider is authorized to fill the order for goods or services as described in the source's email message. When the provider receives the confirming email from the source, the provider is then authorized to fill the order for goods or services in the source's order email message.

In another alternative embodiment, completion of the source's order further requires independent verification of the source's order. In this embodiment, the source's order email message is prepared, transmitted to the provider, and acknowledged by the provider as previously described herein. The two-dimensional bar code is scanned and data from the scan is used to prepare the email message. The email message is then transmitted to a provider who compares the source to a set of authorized sources. When at least one of the authorized sources in the set of authorized sources matches the source of the email message, the provider transmits an acknowledgement email to the source. In this embodiment, further independent verification of the source's email message is executed through a requirement that an identification code be transmitted to the provider from a source that is independent of the transmission of the source's email message. The identification code may be in the form of a two-dimensional bar code, sometimes referred to as a “QR code” or may be a string of alpha-numeric characters. The identification code is received by the provider and compared with a set of pre-approved, authorized identification codes that are maintained by the provider. If there is a positive comparison between the identification code that is received by the provider and at least one member in the set of identification codes (meaning that the compared codes are identical), and at least one of the authorized sources in the set of authorized sources matches the source of the email message (meaning that the compared sources are identical), the provider transmits an acknowledgement to the source that the provider has received both the email message and the identification code. The provider then proceeds to complete the order according content of the order email message.

In still another embodiment of the disclosed method, the method includes the steps for acknowledging both the source of the email message and an independent identification code as described above. In addition, completion of the order according to the source's email message may be conditioned on further steps in which the source must receive the acknowledgement email and acknowledgement of the identification code from the provider. The source then prepares and transmits an email that confirms that the provider is authorized to fill the order for goods or services as described in the source's order email message. After the provider receives the confirming email from the source, the provider is then authorized to fill the order for goods or services in the source's email message.

Various other embodiments of the presently disclosed method are also within the scope of the subject invention. For example, the method may allow the source to make edits to the email message that is prepared from the data scanned from the two-dimensional bar code. In another example, the acknowledgement email that the provider transmits may be sent to two or more recipients to afford better coordination as to the timing and details of placement of the order.

Other objects, advantages and features of the presently disclosed invention also will become apparent to those skilled in the art as the description of presently preferred embodiments of the disclosed invention proceeds.

### BRIEF DESCRIPTION OF THE DRAWINGS

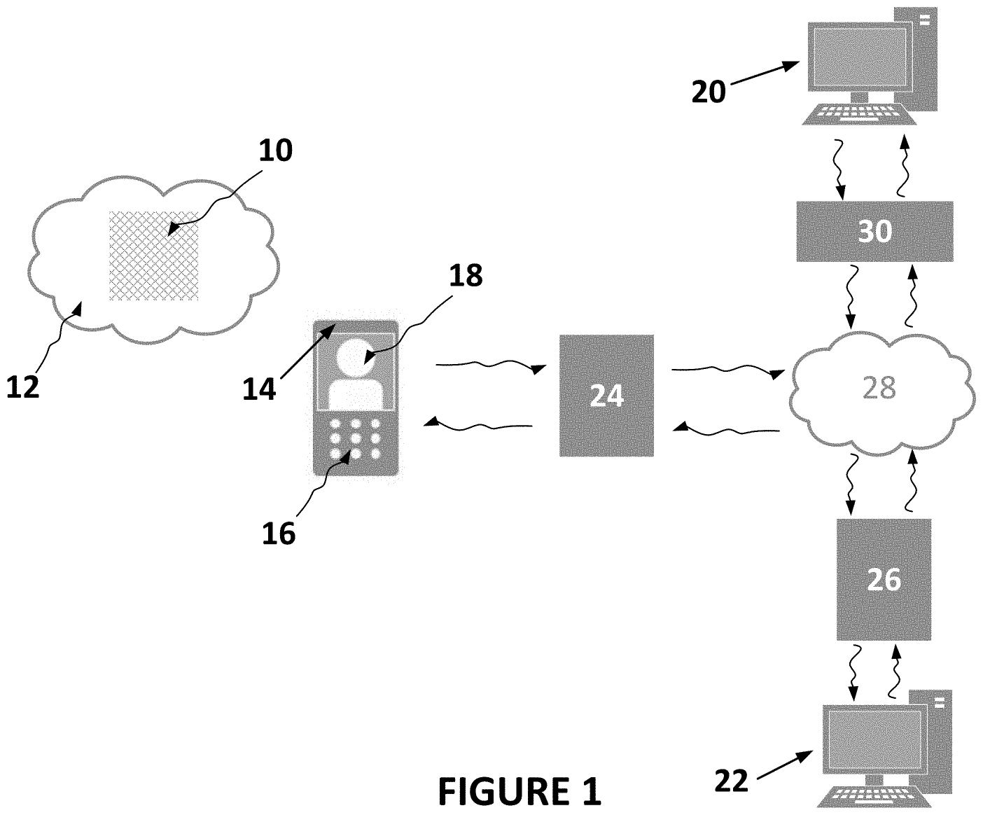

Several presently preferred embodiments of the presently disclosed invention are shown and described in connection with the accompanying drawing wherein FIG. 1 illustrates several alternatives of the disclosed invention.

### DESCRIPTION OF PRESENTLY PREFERRED EMBODIMENTS

A presently preferred embodiment of the invention shown in FIG. 1 includes a two-dimensional bar code 10 (frequently referred to as a QR). As illustrated in FIG. 1, bar code 10 is mounted on a platform 12. In practice, platform 12 can be any stable surface that will support the two-dimensional bar code 10. Examples of platform 12 can include a human-machine interface through which a human operator can communicate with programmable logic controllers to operate various (often complex) process systems such as chemical processes or electro-mechanical systems such as electrical power generation plants. Other examples of platform 12 can include machines or machine parts that wear over time and for which a future need for replacement is anticipated.

According to the presently disclosed method, bar code 10 is scanned by a QR reader. Data from the scanned image is transferred to a microprocessor that generates a suitable email message that incorporates the data from the scanned image. Bar code 10 may include data that identifies the source of said email message such as the name and location of the plant or factory where the bar code is scanned or where the goods or services are to be delivered. Also, bar code 10 may include data that describes details of the goods and services that are being ordered as well as the quantity of such goods and services and the identity of the specific supplier from which the goods or services are to be ordered. Still other information such as a description of the full ordering procedure (i.e. the source's order protocol) may also be included in the data of bar code 10 that the microprocessor incorporates in the email message. In addition, the microprocessor may incorporate other data such as an identification of the specific QR reader that is used to execute the scan of bar code 10. In this way, the microprocessor may generate an email message in response to a scan of two-dimensional bar code 10 wherein said email message includes content that identifies the source of said email message and that also requests details for the provision of goods or services. Because the details are established in the two-dimensional bar code, there is no occasion for the introduction of order entry errors due to operator errors or inadvertent key strokes.

In some cases, an iPhone™ 14 that includes a camera such as illustrated in FIG. 1 may be used to scan bar code 10 through the camera lens of the iPhone. In that embodiment, the iPhone includes capability for automatically generating the order email message when the camera lens scans bar code 10. An operator command may then send the automatically generated message to the iPhone email function.

When the microprocessor or iPhone has generated the email message and it is sent to the iPhone email platform, a human operator may send the order email message by a command that is entered through an interface such a keypad 16 or a touch screen 18. In some cases, the human operator may be authorized to make edits to the email message before sending the order email message. Such edits may, for example, include changes to the quantity of goods or to the model of the goods. In some cases, the human operator may be authorized to make such changes, but only within a prescribed range of choices. As a non-limiting example, the operator may have authority to add up to three more additional units to the quantity that is stated in the prepared order email message, but does not have authority to amend the email message to increase the number of units that are ordered by more than three.

In some cases, the ordering protocol may require that a third party approve the email message that is sent. As a non-limiting example, the ordering protocol may require that a supervisor approve the email message for an order for goods or services by entering an identification code from a computer that is separate from iPhone 14. In such cases, the third party may send an identification code to the same supplier or provider to which the email message is sent. As explained further herein, the supplier or provider can process that identification code to fulfill the requirements of the ordering protocol.

The email message that is prepared by scanning the two-dimensional bar code with a bar code scanner and generating an email message based on data collected in the scan is transmitted to a provider. In the several examples of FIG. 1, the email message that is generated in iPhone 14 is transmitted to a computer 22 that is maintained by the provider of the goods or services. The supplier or provider may, for example, be a manufacturer goods or a purveyor of services or may be an intermediary supplier for such goods or services such as a distributor or temp agency.

Transmission of the email message to the provider may be according to any of the commercial communication channels by which emails are transmitted. In the example of FIG. 1, it is illustrated that iPhone 14 is wirelessly connected to a server 24 that communicates electronically with another server 26 through cloud communication 28. Server 26 includes a transmitter/receiver and is wirelessly connected to computer 22 of the provider.

In embodiments of the disclosed method wherein the applicable ordering protocol also requires an independent identification code to fulfill the ordering protocol, the ordering protocol may require that a supervisor or other third party approve the email message for an order for goods or services by entering an identification code from a computer that is separate and independent from iPhone 14. In such cases, the third party may send an identification code to the same supplier to which the order email message is sent. In the examples of FIG. 1, the ordering protocol may require that a supervisor approve the email message generated from iPhone 14. In FIG. 1, the supervisor may use a computer 20 to enter and transmit the identification code. The identification code is transmitted from computer 20 to computer 22 of the provider through any of the known communication channels by which emails are transmitted. FIG. 1 illustrates that computer 20 is wirelessly connected to a server 30 that communicates electronically with server 26 through cloud communication 28. As previously described, server 26 is wirelessly connected to computer 22 of the provider. In this way, the third-party supervisor may send an identification code to the same supplier to which the email message from iPhone 14 is transmitted.

In the illustration of FIG. 1, computer 22 includes a transmitter/receiver combination for wirelessly communicating with server 26. Computer 22 also includes a memory for storing a set of authorized email sources and a processor for comparing the source of email messages that are received from server 26 against the individual email sources that compose the set of authorized email sources. At a time before any order email is sent, the source and the provider agree as to the identity of at least one of the authorized email sources that are to be included in the set. In some cases, the provider may make similar agreements with other sources for respective orders from those other source and for the respective supply of goods and services to those other sources. In this way, the provider may employ the same method for securing order completion with respect to multiple sources.

The provider saves each authorized email source to which they have previously agreed in the memory of computer 22. When computer 22 receives an order email message that purports to be from a source, the processor in computer 22 compares the source identified in the email message to authorized email sources in the set of authorized email sources. If the source identified in the order email message matches at least one of the authorized email sources in the set, computer 22 determines that there is a positive comparison. Based on the positive comparison, computer 22 generates an acknowledgement that the provider has received the source's order email message requesting goods or services. Such acknowledgement email is then transmitted back to the source at iPhone 14 through server 26, cloud 28 and server 24. In some cases, the acknowledgement may be transmitted to more than one email recipient for the source according to the ordering protocol established by the source.

In embodiments wherein the source's order protocol requires an identification code that is independent from the source's email message, the identification code may be confirmed in a manner similar that in which the source's order email message is confirmed. More specifically, the source and the provider previously agree as to at least one authentic identification code to be used. The provider then stores the at least one authentic identification code in the memory of computer 22. In some cases, the provider may make similar agreements with other sources for the respective supply of goods and services to those other sources. In this way, the provider may employ the same method for secure order completion with respect to multiple sources.

The provider saves each authentic identification code on which they have previously agreed in the memory of computer 22. When computer 22 receives an identification code that purports to be from an authorized source, computer 22 compares the identification code that is received against the authentic identification codes that are saved in the computer memory. If the identification code that is received at computer 22 matches at least one of the authorized identification codes, computer 22 determines that there is a positive comparison. Based on the positive comparison of the identification code (together with a positive comparison of the source), computer 22 generates an acknowledgement that the provider has received the source's email message requesting goods or services. The acknowledgement email is then transmitted back to the source at iPhone 14 through server 26, cloud 28 and server 24. In some cases, the acknowledgement may be transmitted (additionally or alternatively) to more than one email recipient such as the independent third-party supervisor for the source, a person responsible for the source's accounts payable, or other email recipients according to the order protocol established by the source.

After the provider sends the acknowledgement email to the source, the provider is authorized to complete the order by providing goods or services to the source according to the established protocol. However, in some examples, the source's order protocol may require additional steps before the provider proceeds to complete the order. For example, the provider may not be authorized to proceed to complete an order according to the source's email message until the source receives the acknowledgement email from the provider and then transmits a confirmation message back to the provider. In such cases, the provider is authorized to complete the order according to the terms of the order email message only after the provider has received such confirmation message.

Other embodiments, aspects and features of the presently disclosed invention are more particularly set forth in the scope of the following claims.

We claim:

1. A secure ordering method, said method comprising the steps of:
scanning a two-dimensional bar code that has been fixed to a platform;
generating an email message in response to said step of scanning the two-dimensional bar code, wherein said email message includes content that identifies the source of said email message and that also requests the provision of goods or services;
transmitting said email message that requests goods or services to a provider of such goods or services;
receiving said transmitted email message that requests goods or services by a provider of said goods or services;
comparing the source identified in said email message that has been received by said provider of said goods and services with respect to a set of authorized email sources that includes a plurality of individual email sources;
transmitting an acknowledgement that said provider of goods and services has received said email message that requests goods or services, said acknowledgement that said email message has been received being transmitted only after the source in the content of said email message requesting goods or services is positively confirmed to match at least one individual email source in said set of authorized email sources; and
processing the content of said email message that requests goods or services by said provider

2. The method of claim 1 further comprising the steps of:
receiving said acknowledgement that is transmitted by said provider of goods or services;
transmitting a confirmation message to said provider, said confirmation message authorizing said provider to process the content of said email message that requests said goods or services;
receiving said confirmation message by said provider of goods or services; and
processing the content of said email message that requests goods or services only after said provider has received said confirmation message.

3. The method of claim 1 further comprising the steps of:
transmitting an identification code to said provider of said goods or services, said identification code being transmitted separately from the transmission of said email message that requests goods or services;
receiving said identification code by said provider of said goods or services in addition to receiving said transmitted email message that requests goods or services by said provider of said goods or services;
comparing said identification code received by said provider of said goods or services with respect to a set of authorized identification codes that includes individual identification codes, said comparing said identification code being in addition to said step of comparing the source identified in said email message that has been received by said provider of said goods and services with respect to a set of authorized email sources that includes a plurality of individual email sources;
transmitting an acknowledgement that said provider of goods and services has received said identification code, said acknowledgement that said identification code has been received being transmitted only after the identification code is positively confirmed to match at least one individual identification code in said set of identification codes, said transmitting an acknowledgement of said identification code being in addition to said step of transmitting an acknowledgement that said provider of goods and services has received said email message that requests goods or services; and
processing the content of said email message that requests goods or services by said provider.

4. The method of claim 3 further comprising the steps of:
receiving said acknowledgement that said provider of goods or services has received said identification code and also receiving said acknowledgement that said provider of goods and services has received said email message that requests goods or services;
transmitting a confirmation message to said provider, said confirmation message authorizing said provider to process the content of said email message that requests said goods or services;
receiving said confirmation message by said provider of goods or services; and
processing the content of said email message that requests goods or services only after said provider has received said confirmation message.

5. The method of claim 1 wherein the content of said email message that identifies the description or quantity of said goods or services can be edited to change the description or quantity of said goods or services after said email message is created from said scan of said two-dimensional bar code and before said email message is transmitted to said provider of said goods or services.

6. The method of claim 5 wherein editing of the description or quantity of said goods or services is restricted within predetermined boundaries or limits.

7. The method of claim 1 wherein said step of transmitting an acknowledgement that said provider of goods and services has received said email message that requests goods or services comprises transmitting said acknowledgement to more than one recipient.

8. The method of claim 7 wherein said more than one recipient of said acknowledgement include email addresses corresponding to any of the source of said email message, a supervisor for the source of said email message, and a person responsible for accounts payable by said source of said email message.

9. The method of claim 3 wherein said step of transmitting an acknowledgement that said provider of goods and services has received said email message that requests goods or services comprises transmitting said acknowledgement to the source of the separately transmitted identification code.

10. The method of claim 1 wherein said email message further includes content that identifies steps in the procedure for completing the order of goods or services.

11. The method of claim 1 wherein said two-dimensional code is unique to each source.
